(19) United States
(12) Patent Application Publication
(10) Pub. No.: US 2017/0240089 A1
(43) Pub. Date: Aug. 24, 2017

(54) Mini-Camper Attachable to Vehicle Hitch Receiver

(71) Applicant: Mark Tait, Mt. Pleasant, PA (US)

(72) Inventor: Mark Tait, Mt. Pleasant, PA (US)

(21) Appl. No.: 15/441,227

(22) Filed: Feb. 23, 2017

Related U.S. Application Data
(63) Continuation-in-part of application No. 15/052,035, filed on Feb. 24, 2016.

(51) Int. Cl. B60P 3/34; B60S 9/04

(52) U.S. Cl. CPC B60P 3/34; B60S 9/04

(57) ABSTRACT

The present invention relates to a camper that is hauled by a vehicle. The camper is collapsible into a compact easy traveling position that is connected to a hitch receiver on the vehicle. The camper in the collapsed travel position fastened to a vehicle hitch does not have any wheels making contact with the roadway or ground. The camper in its collapsed position has an equal or higher ground clearance as the ground clearance of the vehicle it is attached to so as not to encumber off-road or roadway travel. The camper of the present invention is not mounted on a trailer and has handles for positioning and rolling the camper about.

### RELATED APPLICATIONS

This patent application is a continuation-in-part application of application Ser. No. 15/052,035, filed Feb. 24, 2016, similarly entitled “Mini-Camper Attachable to Vehicle Hitch Receiver”.

### FIELD OF THE INVENTION

The present invention relates to a camper that is hauled by a vehicle. The camper is collapsible into a compact easy traveling position that is connected to a hitch receiver on the vehicle. The camper in the collapsed travel position and fastened to a vehicle hitch does not have any wheels making contact with the roadway. The camper in its collapsed position has an equal or higher ground clearance as the ground clearance of the vehicle it is attached to so as not to encumber off-road or roadway travel. The small camper of the present invention is not mounted on a trailer and does not require a trailer.

### BACKGROUND OF THE INVENTION

There is a preference for some consumers in the camping industry toward smaller and lighter towed camping trailers, and smaller and lighter car campers. A market exists for one and two person campers that are convenient for short overnight stays but can also be used in combination with other traditional camping equipment shelters such as camping gazebos and camping canopies as may be desired for additional living room during longer period overnight stays.

In the industry today there are fixed camper trailers, see for instance U.S. Pat. No. 8,393,643 (Mace) and U.S. Pat. No. 8,132,849 (Gerbracht). There are collapsible camper trailer types, see U.S. Pat. No. 4,165,117 and U.S. Pat. No. 3,941,414 (Platt). And there are also pop-up tent trailer types, see U.S. Pat. No. 3,455,596 (Krutzikowsky) and U.S. Pat. No. 2,957,482 (Tomek).

The majority of the conventional camper trailers, whether designed to be a fixed or collapsible structure, are heavy and large and can be difficult and time consuming to set-up and take-down on a camping trip. This defeats the real purpose of the easiness and readiness that consumers desire in a camper for a spur-of-moment decision to take a short overnight vacation, such as a weekend vacation.

Such large and heavy conventional campers make transportation less safe. Often the suspension, frame, brakes and other original structure on a vehicle must be made stronger or otherwise changed to accommodate a heavy trailer.

Hauling a trailer can be unwieldy and a challenge for even an experienced driver when maneuvering to park. Also, a trailer is typically prone to sway and causes vehicle handling problems.

Conventional trailers require a consumer to have plenty of additional space for storage whenever such trailers are not in use. In addition, all states have laws that require trailers to be registered and licensed. A few states require some camping trailers to be inspected.

Conventional pop-up tent trailer campers and some collapsible camper trailers are more aerodynamic and fuel efficient than a fixed camper trailer. However, the time requirement and difficulty in assembling and disassembling large trailer pop-up tents and camper trailers is undesirable for the consumer. This is a consideration whenever a person makes an attempt to place the pop-up tent trailer or collapsible camper trailers in use under unfavorable conditions, such as rain, snow, wind, and darkness. Also, pop-up tents and some pop-up camper trailers in part are made of canvas and do not fare well in windy conditions or maintain heat inside very well.

In consideration of the above, it is a primary object to provide an erectable sleeping compartment for a vehicle which overcomes or substantially alleviates the shortcomings and problems of the prior art.

There is a need in the art for a camper which is safe and not cumbersome during transportation. A camper that is quick and easy to set-up and take-down upon arrival and departure from campsites is needed. There is a desire for a camper that is relatively small in size and does not require additional hardware to strengthen or modify a vehicle. A compact camper is desired that does not require excessive storage when not in use and that is more aerodynamic during roadway transportation for improving fuel economy and does not substantially obstruct a driver's rear view vision.

### SUMMARY

In a preferred embodiment of the present invention, a vehicle attached camper includes a rigid rectangular floor, vertical base walls fixed to the floor and an upper collapsible/expandable portion. The camper walls and roof are not constructed of canvas but are constructed of a rigid material. The camper when erected into its camping position creates an enclosure of a size and shape suitable for sleeping at least one adult. The collapsible/expandable portion includes two pivotally mounted half shells on the opposing distant ends of the rectangular floor. Each half shell includes a sidewall and an angled roof portion. The two half shells are pivotally attached to the central floor and can be quickly erected into a sleeping position from a compact collapsed travel position. The camper half shells together form a truncated triangular arch roof and two vertical sidewalk. A base wall extends vertically upward from the rear edge of the floor. A front entrance is located on the side opposite of the rear wall. The entrance is defined in part by two symmetric front base walls extending vertically upward from the floor. The rear gable wall and front wall panels are hinged onto their respective base walls and can be easily folded into a short collapsed travel/storage position.

It is not necessary to remove the camper from the hitch during a camping outing it may be erected into its sleeping position while remaining on the vehicle hitch. The camper has pivotally attached adjustable ground support legs located on the camper for assisting in stabilizing the camper while erected into its sleeping position on the hitch.

Likewise, the present camper can be easily collapsed from its erected position into its low profile compact position while remaining on the hitch.

Another second preferred embodiment comprises a collapsible/expandable rigid camper as described with respect to the first preferred embodiment which additionally includes wheels positioned near one end of a central floor of the camper. Whereby said camper can be manually rolled to campsites or other locations in a less cumbersome manner after being taken off the vehicle hitch. The camper has four leg supports that are adjustable in height so as to enable a person to set-up the camper in a level sleeping position away from the vehicle.

Another object of the present invention is to provide a collapsible camper constructed of only rigid materials including rigid walls and a rigid roof that can be easily collapsed into a compact low profile for road traveling or placing it into storage. The camper in one preferred embodiment is made from a rigid strong composite material yet the material is light weight enough so as to permit a single individual to lift/lower the collapsed camper on or off a hitch attachment. Such construction using composite materials in comparison to canvas camping shelters/tents provides better security from at least small animals when camping outdoors.

It is an important object of the invention to provide an erectable and collapsible sleeping compartment which is stored independent of a vehicles storage or other space. The camper is quickly and easily attached behind a vehicle by using a bar attached to the vehicle hitch receiver. After driving the vehicle attached camper to a camping location and parking, a person can erect the camper into a usable sleeping position while the camper is still supported on the bar and attached to the vehicle.

Another object of this invention is to provide a camper which when collapsed is substantially reduced in height as compared to its erected height. And the camper does not illegally obstruct the rear lights of a vehicle, including but not limited to tail lights, parking lights, turn signals, backup lights and braking lights. Alternatively, if it is impractical or undesirable to raise or lower the camper as needed for legally visible rear lights on a particular vehicle, it is contemplated that in a preferred embodiment that the rear lights of a vehicle, including but not limited to tail lights, parking lights, turn signals, backup lights and braking lights could be integrated into the design of the small camper. For instance, lights could be positioned on the collapsed camper side facing traffic behind the pick-up truck, see FIG. 2, as it moves on down the highway. Such integrated camper lights can be connected to the vehicle electrical control system using a well-known adaptor as are commonly employed on trailers towed behind small private vehicles.

Another object of this invention is to provide a neat appearing small camper which is not greatly affected by the outdoors and is substantially resistant to wind and rain. In a preferred embodiment all the camper base walls and the collapsible/expandable structures are made of a composite rigid insulative material. The composite material is also preferably waterproof.

It is contemplated that during very substantial wind the camper is preferably hitched to a vehicle so as to prevent it from being toppled over.

A further object of the present invention is to provide a collapsible camper having a high degree of weather tightness against both wind and rain when it is erected.

At least one roof portion on a half shell has a seal on an extremity near the camper's central axis so as to form a weather tight abutment with the other half shell roof portion when in the erected position. The front and rear edges of the erected triangular arch roof are provided with flanges or edge borders so as to form a weather tight abutment surface with the cooperating rear gable wall and front wall panels. A first half shell's outer sidewall and integral roof portion have a slightly larger width dimension than the opposing second half shells sidewall and integral roof portion. This width dimension is sufficiently large enough so that said first half shell envelopes said second half shell when the camper is in the collapsed position. It should also be appreciated from the drawings, in particular FIG. 2, that the width dimensions of both the first half shell and second half shell are greater than the width of the rectangular floor so as to enable the half shells to pivot from the erected position into the collapsed position without being impeded by interference with either the central floor or base walls.

The present invention relates to a vehicle and small camper coupled together in a more convenient method vet safer method.

The invention is described as a small camper suitable for attachment to a hitch receiver on a vehicle so as not to inhibit the vehicles original ground clearance. The small collapsed camper is attached to a bar and held in a horizontal transport position above the road surface and does not substantially obstruct a driver's rear view vision.

Other objects and advantages of the present invention will become apparent from the detailed description of preferred embodiments which follow, when read in conjunction with the drawings.

### BRIEF DESCRIPTION OF THE DRAWINGS

FIG. 1 is rear view of a vehicle equipped with a preferred collapsible/expandable camper, in accordance with the present invention, shown in its erected sleeping position;

FIG. 2 is rear view of a vehicle equipped with a preferred collapsible/expandable camper, in accordance with the present invention, shown in its collapsed travel position;

FIG. 3 is an exploded view of the present camper invention;

FIG. 4 illustrates a side elevation view of the present camper invention and its vehicle attaching apparatus in exploded form illustrating how it can be secured to a vehicle;

FIG. 5 is a perspective view of a second wheeled embodiment of the invention in its erected sleeping position unhitched from a transport vehicle and independently supported by ground legs.

FIG. 6 is an perspective view of a third embodiment of the invention in its collapsed position ready for attachment to a carrier frame coupled to a vehicle hitch receiver;

FIG. 7 is a partially exploded view of the camper of the present invention;

FIG. 8 is a perspective view of the carrier frame for the third embodiment.

FIG. 9 is rear view of a vehicle equipped with the preferred third embodiment of collapsible/expandable camper, in accordance with the present invention, shown in its erected sleeping position

### DETAILED DESCRIPTION

The invention is described as a small camper suitable for attachment to a hitch receiver on a vehicle. A characteristic of the present invention is that it employs a support bar that is inserted in the hitch receiver, the bar extends rearward of the hitch receiver, the small camper has a receiver means underneath the camper floor for straddling or surrounding the support bar. The small camper is attached to the bar and held in a horizontal transport position having substantial ground clearance above the road surface.

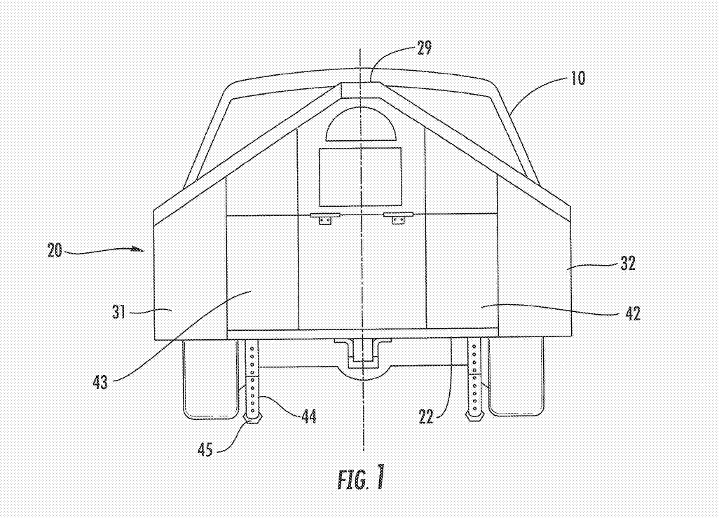

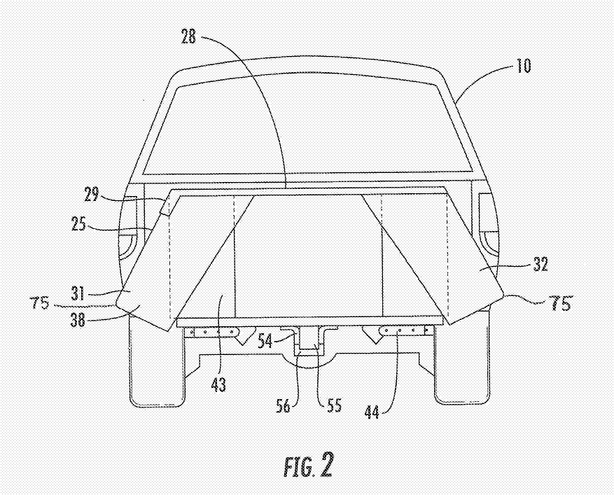

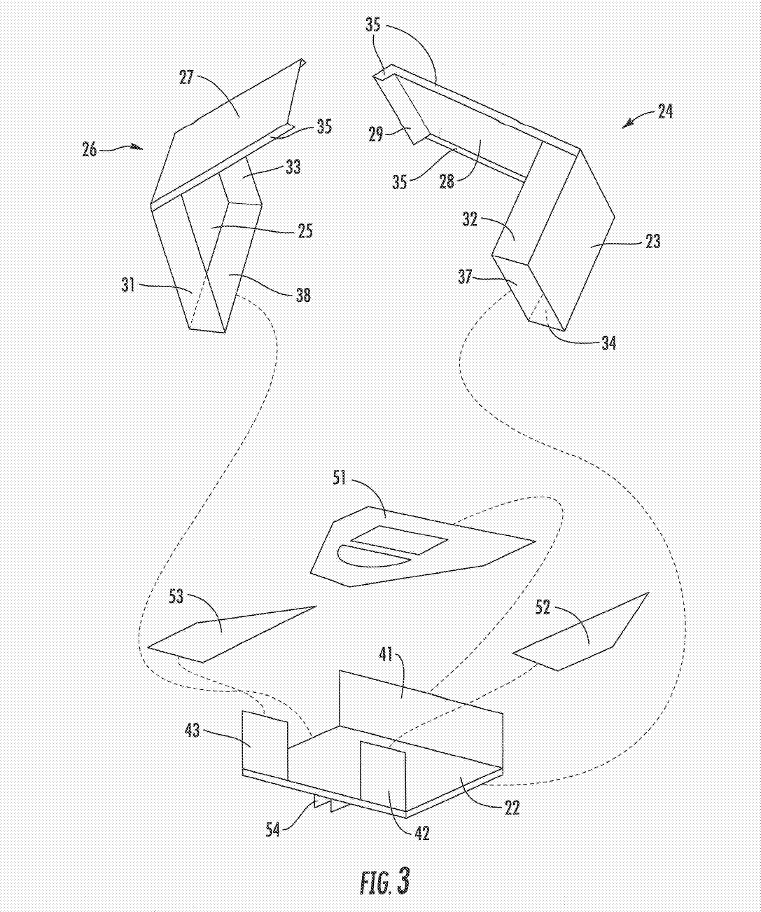

In a preferred embodiment of the present invention, a vehicle attached camper includes a rigid rectangular floor supporting a collapsible/expandable portion. The camper walls and roof are not constructed of canvas but are constructed of a rigid material. The camper when erected into its sleeping position creates an enclosure of a size and shape suitable for sleeping at least one adult. The collapsible/expandable portion includes two pivotally mounted half shells located near the opposite ends of the central rectangular floor. Each half shell includes a sidewall and an angled roof portion. The two half shells are pivotally attached to the floor and can be quickly erected into a sleeping position from a collapsed travel position. The erected camper half shells together form a triangular arch roof and two vertical sidewalls. A base wall extends vertically upward from the rear edge of the floor. A front entrance is located on the opposite side of the rear wall. The entrance is defined in part by two symmetric front base walls extending vertical upward from the floor. The rear gable wall and front wall panels are hingedly interconnected with their respective base wall sections and arranged to be folded into a short collapsed position. Referring to FIG. 1, reference number 10 is a vehicle, a pick-up truck. The present invention camper is fastened to the vehicle. Numeral 20 designates the camper of the present invention in its erected sleeping position. Camper 20 includes a rigid rectangular floor 22 for supporting a collapsible/expandable portion. The collapsible/expandable portion includes two pivotally mounted half shells 24, 26, as best shown in FIG. 3, attached at opposite far ends of the rectangular floor 22. Each half shell 24, 26 includes a sidewall 23, 25 and an angled roof portion 27, 28. The two half shells 24, 26 can be pivoted between a sleeping position as shown in FIG. 1 and a compact collapsed position as shown in FIG. 2. The sidewall 23 and roof 28 of the half shell 24 are slightly wider than the width of the sidewall 25 and roof 27 of half shell 26, so that half shell 24 may substantially envelope half shell 26 when the camper is in the compact collapsed position.

From the collapsed position the two half shells 24, 26 can be quickly erected into a sleeping position, as shown in FIG. 1, by pivoting the two half shells outward from the central vertical axis of the camper. To facilitate the pivoting of the half shells as aforesaid, any satisfactory handle means may be secured to the sidewalls 23, 28 for assisting in lowering and raising the half shells between their sleeping and travel positions. In the sleeping position, as shown in FIG. 1, the camper half shells together form a substantially triangular arch roof, two vertical sidewalls 23, 25, and bottom surfaces 37, 38. The bottom surfaces 37, 38 in the erected sleeping position cooperate with the central floor 22 to form a substantially even horizontal surface from one sidewall 23 to the other sidewall 25. The half shells further comprise of rear wall 33, 34 sections and front wall sections 31, 32.

The camper half shells are positioned at opposite ends of the floor and when the camper is in the sleeping position both half shells roof portions extend to near the central vertical axis of the camper. As illustrated in FIG. 1 the far end roof portion of half shell 24 extends across the central vertical axis so as to slightly overlap the roof portion of half shell 26. Conventional abutment surfaces are employed to properly locate and position the two half-shells 27, 28 in the erected position. A roof top portion 29 of the triangular arch roof forms an uppermost flat horizontal surface.

Suitable connection means such as hooks, sliding bolts, latches or other well-known means in the art may be employed at the uppermost roof top to fix the two half shells 24, 26, together when in the sleeping position. See U.S. Pat. No. 2,626,832 (Guthoerl) which is incorporated herein by reference in its entirety. Also see U.S. Pat. No. 4,027,912 (Pacca) which is incorporated herein by reference in its entirety. Similarly, other well-known connection means maybe employed to fix the two half shells 24, 26 together when the camper is in the compact collapsed position of FIG. 2 so that the camper does not become unfolded as it travels down the roadway.

Roof sections 27, 28 have weatherstrips 35 on both their forward and rearward border edges. The upper ends of front wall panels 52, 53 and upper end of rear gable wall 51 substantially abut against weatherstrips 35 when the camper is in its sleeping position. The inside surfaces of the weatherstrips 35 may include resilient seals to help maintain a more comfortable environment inside the camper. In the collapsed position half shell 24, is arranged on top of half shell 26, the weatherstrips 35 assist in aligning and maintaining shells 24, 26 together.

All joints and/or abutment surfaces between half shells and wall portions, or wall portions with other wall portions and/or weatherstrips may be provided with suitable seals means well-known in the art. In a preferred embodiment, an inner flange or groove may be provided adjacent the outer extremity of top portion 29 for cooperation with a liquid tight resilient seal near the extremity of roof section 27. In a preferred embodiment a rainproof camper may be achieved by adopting thin sealing strips of foam rubber or foamed plastic material cemented along appropriate edges or surfaces about the entire camper.

Base walls 41, 42, 43 extend vertically upward from floor 22. A front entrance (not numbered) is centrally located on the opposite side of the rear base wall 41. The entrance is partially defined by two symmetric front base walls 42, 43 extending vertically upward from the floor 22.

A rear gable wall 51 is pivotally connected to the upper extremity of the rear base wall 41 by hinge means (not numbered), and front wall panels 52, 53 are pivotally connected to the upper extremity the front base walls 42, 43 respectively. The gable wall portion 51 and two front wall panels 52, 53 can be manually folded inward into a short collapsed position.

The rear gable wall may not have windows or may have windows numbered) as illustrated in FIGS. 1 and 3, the window may be formed from a transparent plastic material. The front entrance may be provided with a swinging gate (not shown) between the front base wall sections 42, 43 for limiting access into the camper.

Once the aforesaid half shells are rotated and fixed into the sleeping position, the folded over rear gable wall 51 can be simply erected by pivoting it about its hinges into a vertical position. Next the front panels 52, 53 can be manually rotated up into their vertical positions. After each of the structure parts 24, 26, 51, 52, 53 is rotated into its sleeping position they may be provided with manual connecting means to secure these structure parts of the camper in place.

As seen in FIG. 1, the camper has support legs 44 for supporting for the camper on the ground. The support legs are pivotally connected to the underside of the floor. Preferably there are four adjustable support legs attached near the four corners of the central rigid floor to provide for better stability of the camper. Each support leg has an upper receiving member which in a preferred embodiment may be made from two-inch square rectangular steel tubing having two juxtaposed drilled through holes along its entire length, the support legs have lower telescoping members sized to be telescopically received in their respective upper members. The lower members of the supporting legs likewise have a series of vertically disposed drilled through holes along their entire length. Each leg has a height adjustment pin that is insertable into cooperating aligned holes of the upper and lower member. Whereby the level of the foot 45 on a leg can be raised or lowered to conform to ground level. Each support leg 44 is pivotally attached to the underside of the floor 22 so that they may be rotated from a vertical support position, as shown in FIG. 1, to a horizontal travel position as shown in FIG. 2.

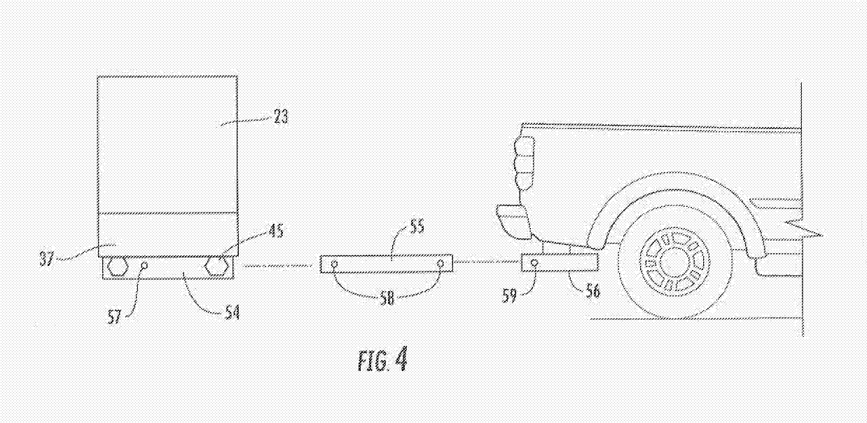

In FIG. 4 a floor receiver means 54 attached to the underside of the floor is illustrated. In the illustrated embodiment of FIG. 4 the floor receiver means is an open saddle 54 that is adapted to straddle bar 55. The floor receiver means in the preferred embodiment bisects the floor extending straight across the width of the floor from a forward side edge, adjacent the vehicle, to the opposite rear side edge. However, it should be appreciated that the floor receiver means may not necessarily extend across the entire width of the camper floor. The bar 55 has two sets of juxtaposed drilled through holes 58, one set adjacent each end of the coupler bar 55. A hitch receiver 56 is fixed onto the undercarriage of the vehicle in the present invention. The bar 55 is inserted into the hitch receiver 56 and the camper is straddled over the coupler bar 55. The coupler bar is fastened to the hitch receiver at one end by an insertion pin that is passed through aligned openings 58 and 59 and the camper is fastened onto the bar at its other end by a pin inserted through aligned holes 57 and 58. Whereby the camper is now securely coupled onto the vehicle so that a person may embark on a camping trip.

As seen in FIG. 2, the all the rear lights on the pickup truck are legally visible. It is contemplated that in the alternative that well-known adaptor means, including but not limited to size, shape and/or raise/drop adaptors may be first connected to the hitch receiver and the coupler bar 55 is then coupled to the adaptor means. A raise/drop adaptor may be selected and employed so that the collapsed camper does not illegally obstruct the rear lights of a vehicle, including but not limited to tail lights, parking lights, turn signals, backup lights and braking lights. See U.S. Pat. No. 4,280,713 (Bruhn) which is incorporated herein by reference in its entirety. Other well-known methods for raising or lowering the vehicle hitching position as needed may also be employed, see both U.S. Pat. No. 5,649,656 (Davy) and U.S. Pat No. 5,950,890 (Darby) which are both incorporated herein by reference in their entirety. However, a hitch “drop” adaptor may not be desirable as it would unduly impede on ground clearance or the vehicle aerodynamics during travel. Alternatively, if it is impractical or undesirable to raise or lower the camper as needed for legally visible rear lights, it is contemplated that in a preferred embodiment that the rear lights of a vehicle, including but not limited to tail lights, parking lights, turn signals, backup lights and braking lights could be integrated into the design of the small camper. For instance, lights could be positioned on the collapsed camper side facing traffic behind the pick-up truck, see FIG. 2, as it moves on down the highway. Such integrated camper lights can be connected to the vehicle electrical control system using a well-known adaptor as are commonly employed on trailers towed behind small private vehicles.

It is contemplated that the floor receiver means may alternatively be a hollow structural section instead of an open saddle as well-known in the art, see U.S. Pat. No. 8,505,932 (Piccirillo) Which is herein incorporated by reference in its entirety.

The coupler support bar 55 holds the camper in a horizontal plane so that it will be substantially parallel to the road surface during travel. The floor 22 is fixed in this horizontal plane above the hitch receiver so as to provide for adequate ground clearance during travel. The support legs 44 in their retracted travel position, as shown in FIG. 2, are located adjacent the underside of the floor 22. As illustrated in FIGS. 2 and 4, with the camper in the travel position, the foot 45 of each support leg is located above the bottom edges of the saddle means 54. The bottom edges of the saddle 54 as shown in FIGS. 1 and 2 do not extend beyond the bottom surface of the support bar 55 or below the hitch receiver 56. The entire camper is located completely above the bottom of the hitch receiver. Consequently, the ground clearance of the attached camper does not compromise the original ground clearance of the vehicle.

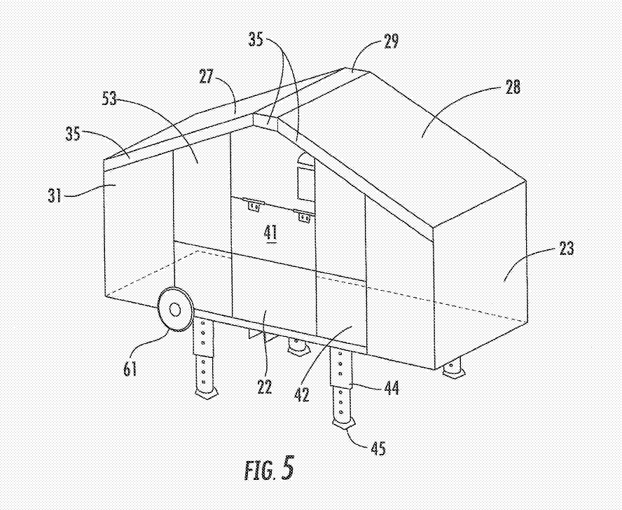

FIG. 5 discloses a second preferred embodiment of the invention. FIG. 5 mostly discloses common elements with the first embodiment disclosed in FIGS. 1-4. The FIG. 5 embodiment employs the same reference numbers for identifying those common elements. Upon inspection of FIG. 5 it should be appreciated that the second camper embodiment is identical to the first embodiment but for a pair of rotating wheels 61 fixed at one end of the floor 22 (only one is shown in FIG. 5, the other wheel is hidden on the opposite side of camper).

The camper in this second embodiment once in its fully collapsed position may be removed from the coupler bar after removing a conventional insertion pin. The camper may be next set on the ground where an operator may then grasp the opposite end of the camper and lift it onto the wheels 61 and maneuver the camper to a desired location. A person can either pull the fully collapsed camper or roll it along while it rests on wheels 61 much like a wheel barrow or dolly is transported. Wheel means 44 are mounted at one of said closed ends for rolling movement of the container on the ground, the wheels being rotatable on axle means disposed near one end of the base. The wheel means includes a pair of oppositely disposed wheels disposed exteriorly of the base and end-walls without being recessed therein

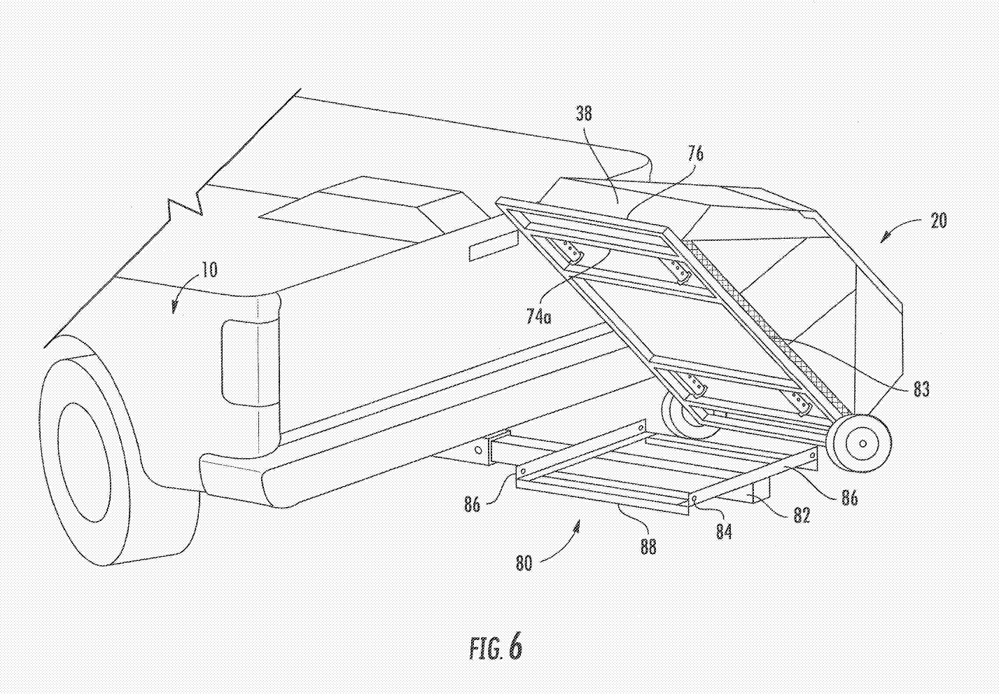

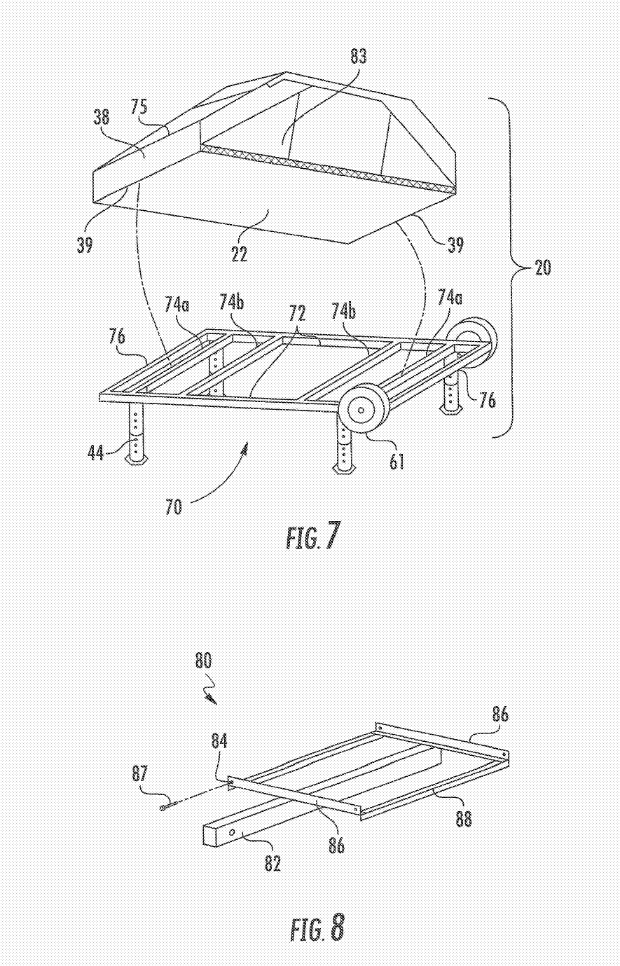

FIG. 6 discloses a third preferred embodiment of the invention. FIG. 6 discloses common elements with the first two embodiments disclosed in FIGS. 1-5. The third embodiment, FIGS. 6-7, employs the same reference numbers for identifying those common elements. Upon inspection of the partially exploded view of the third embodiment in FIG. 7, it should be appreciated that the third camper embodiment is similar to the second embodiment but for an additional light weight metal support frame 70 that is more permanently fixed to the floor 22 underside of the camper. The support legs 44 in the third embodiment are preferably pivotably connected to the support frame 70.

As seen in FIG. 6, a readily separable carrier frame is connected to a hitch receiver on a vehicle. The camper 20 is next secured to the carrier frame 80 by well-known quick connect pins (not shown). The carrier frame has a plurality of pin receiving holes 84 on each of the rails 86 and the camper base walls 41, 42, 43 have a plurality of cooperating pin receiving holes 83 adjacent the camper floor. The camper is first tilted up onto the carrier frame into a horizontal position cradled between the edges of the L-shaped rails 86 between the rails. Once in the horizontal position between the rails 86 the camper can be slid along the rails until the holes 84 in the rails 86 are aligned with the holes in the base walls and a quick connect pin is then inserted through each of the aligned holes coupling the camper 20 to the carrier frame 80. It should be appreciated that other well-known quick fastening means can be employed for coupling the camper onto the carrier frame 80. For instance preferably locking clasps may be used with respect to securing the camper to the carrier frame.

The carrier frame has a central hitch adaptor square tube 82, having permanently fixed thereto are two parallel L-shaped angle irons carrier support rails 86. The carrier rails 86 are oriented perpendicular to the longitudinal axis of the vehicle and carrier adaptor. The inside corner of the two L-shaped rails 86 both face inward to partially cradle the camper between the rails. The carrier support rails 86 are horizontally welded or otherwise secured onto the top surface of the adaptor square tube 82. Each L-shaped rail is oriented so that one of the two perpendicular surfaces is in the vertical plane and the other second surface lies in the horizontal plane. The parallel rails are spaced apart so that the camper closely fits between the rails 86.

The camper has a support frame 70 that is welded or otherwise secured the bottom of camper floor 22. Preferably a lightweight metal including steel or aluminum of appropriate gauge having the required strength may be used to construct the support frame 70. The camper support frame 70 is positioned to be received between the inside corners of the two L-shaped rails. Once the camper is tilted onto the carrier frame rails in a horizontal position, the camper may be manually slid along the carrier frame fully supported. Fastener means can secure the camper to the carrier frame preventing movement during vehicle travel.

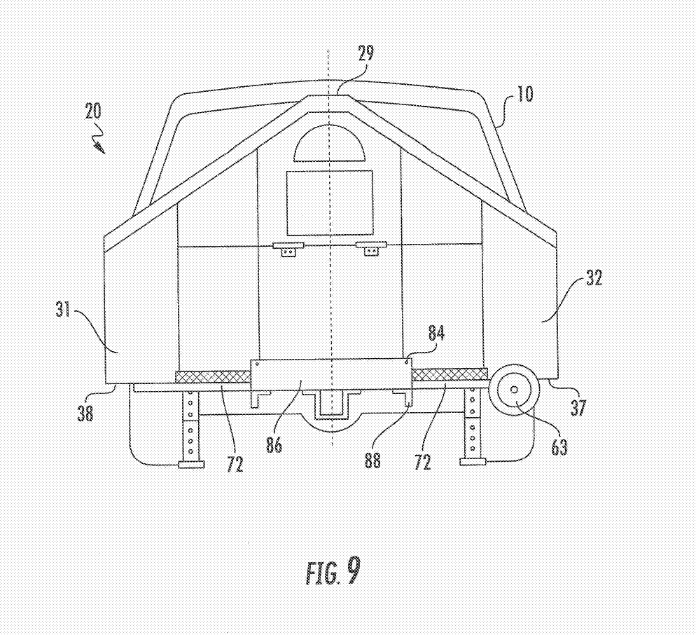

Two support braces 88 provide for additional strength and assist in holding the two rails 84 firmly in position. The support braces 88 shown in FIGS. 6 and 8 may be L-shaped angle irons or other conventional type metal bar that would provide sufficient strength to the carrier frame 80. The carrier frame adaptor 82 allows for easy connection and disconnection of the camper to a conventional hitch receiver found on a vehicle.

In FIG. 7 the support frame 70 for the camper is made from light-weight metal tubing preferably having a square or rectangular cross-section. The support frame 70 comprises two lengthwise support beams 72 and multiple floor cross-beams, outer cross beams 74a and inner cross beams 74b, for supporting the underside of the camper floor 22. The parallel support beams 72 are set apart a distance so that the distance between their outer surfaces is nearly equivalent to the distance between the inner corners of the receiving parallel rails 86 providing a snug fit between the camper and carrier frame 80.

The support frame 70 further includes two parallel handle cross-beams 76 at opposite ends of the support frame 70. These handle cross-beams have two functions, the first function is to provide support to the bottom surfaces 37, 38 of the half shells when the camper is in its sleeping position and their second function is to provide a convenient hand grip for a person when moving the camper while it is in its collapsed position as in FIG. 6. The camper may be moved by a single person. In FIG. 6 the camper is shown in a tilted upright position in preparation for placing it onto the carrier frame 80. The camper has wheel means including a pair of wheels 61 disposed exteriorly near one end of the camper. The handle cross beam 76 provides a means for grasping the camper so a person can move the camper about on its two wheels much like a dolly. Alternatively, whenever the camper is in its collapsed position two persons can lift and carry the camper using the handle cross-beams 76 at opposite ends of the camper.

The wheels 61 are mounted on independent axles 63 that are connected to the support frame 70. The wheel axles are mounted near a handle cross-beam. The axles are mounted near an outward end of the support beams 72 so whenever the collapsed camper is tilted upward for manual transportation, as in FIG. 6, the handle cross beam 76 adjacent the wheels does not contact the ground. As shown in FIG. 7, the wheel axles are not coaxial with the handle cross-beam 76 nor mounted at the end of the support beams 72. They are mounted inward of the handle cross-beam so as to limit the overall length of the camper. It is desirable to limit the overall length of the camper to be at the most equal to the width of a vehicle. Such a camper that is shorter and more compact is more aerodynamic during roadway transportation. Further an overhanging lengthy camper would create added difficulty in avoiding collisions during transportation of the camper on a vehicle.

The longitudinal length of the first embodiment camper in its sleeping position, see FIG. 1 is greater than the length of the camper is in its collapsed travel position, see FIG. 2. In the FIG. 2 collapsed travel position the longitudinal length of the collapsed camper is the distance between the half shell corners 75, this length does not extend beyond the width of the vehicle. Similarly, the longitudinal length of the third embodiment's sleeping position, as shown in FIG. 9, is longer than the length of the third embodiment camper in its collapsed travel position and it extends beyond the width of the vehicle.

As briefly indicated above the handle cross beams 76 support the bottom surfaces 37, 38 of the half shells when the camper is deployed into its sleeping position. The longitudinal length of the support frame is the distance from one handle cross beam 76 to the handle cross beam 76 at the opposite end of the support frame. The two outer parallel cross beams 74a of the support frame are longitudinally located so as to be directly under the two floor ends 39. Both handle cross beams 76 are located substantially outward from the outer cross beams 74a so as to permit a person to grasp the collapsed camper and manually roll it or carry it with another person grasping the handle cross beam at the opposite end as described above.

In this third embodiment the maximum longitudinal length of the support frame 70 is limited so as to be at least less than the longitudinal length of the camper in its sleeping position. The minimum longitudinal length of the support frame 70 is limited so as to permit two people to place their hands around the handle cross beams 76 at each end for lifting and carrying the camper. The longitudinal length of the support frame 70 may be shorter or longer within these minimum and maximum limits.

The longitudinal length of the support frame 70 does not extend from one end of the camper to the other end when in its sleeping position as shown in FIG. 9. Further the support frame 70 has a length that is not more than the overall length of the camper in its collapsed FIG. 2 travel position. The total longitudinal length of the support frame 70 plus any portion of the pair of wheels 61 that extends beyond the support frame is not greater than the longitudinal distance between the third embodiment half shell corners 75 when the camper is in its collapsed travel position. As discussed above the longitudinal length of the camper in its sleeping position, from corner 75 to corner 75 is not greater than the width of the vehicle for safety and better aerodynamic purposes during travel.

While certain novel features of this invention have been shown and described, it is not intended to be limited to the details above, since it will be understood that various omissions, modifications, substitutions and changes in the forms and details of the illustrated invention and in its operation can be made by those skilled in the art without departing in any way from the spirit of the present invention.

The invention claimed is:

1. A small camper carrier frame assembly for coupling to a vehicle comprising:
a camper;
a carrier frame having an adaptor for connection to a hitch receiving means on a vehicle, and
quick fastener means for coupling said camper to said carrier frame.

2. The small camper carrier frame assembly of claim 1, wherein said camper has a support frame.

3. The small camper carrier frame assembly of claim 2, wherein said support frame has two handle cross-beams at opposite ends of said support frames longitudinal axis.

4. The small camper carrier frame assembly of claim 2 wherein said camper has a rigid rectangular floor supporting a collapsable/expandable portion, said collapsable/expandable portion has both an erected sleeping position and a compact collapsed position.

5. The small camper carrier frame assembly of claim 4 wherein said camper in said compact collapsed position has a shorter compact longitudinal length than when said camper is in said erected position; and
said support frame has a longitudinal length shorter than said compact longitudinal length.

6. The small camper carrier frame assembly of claim 5 wherein said longitudinal length of said support frame extends beyond the longitudinal length of said floor so that said handle cross beams may be manually grasped.

7. The small camper carrier frame assembly of claim 6 wherein said support frame has wheel means near one of said support frame ends.

8. The small camper carrier frame assembly of claim 6 wherein said support frame further includes at least one support leg pivotally attached to said support frame.

9. The small camper carrier frame assembly of claim 6 wherein said quick fastener means is a quick connect pin.

10. The small camper carrier frame assembly of claim 6 wherein said carrier frame further includes support braces connected to said rails.

11. A small camper carrier frame assembly for coupling to a vehicle comprising:
a camper having a rigid rectangular floor supporting a collapsable/expandable portion, said collapsable/expandable portion has both an erected sleeping position and a compact collapsed position;
a carrier frame having an adaptor for connection to a hitch receiving means on a vehicle and
a quick fastener means for coupling said camper to said carrier frame.

12. The small camper carrier frame assembly of claim 10, wherein said collapsable/expandable portion comprises two half shells pivotally attached to said floor and said camper further comprises base walls extending vertically upward with respect to said floor.

13. The small camper carrier frame assembly of claim 12, wherein at least four support legs are pivotably connected to said support frame.

14. The small camper carrier frame assembly of claim 13, wherein wheel means are connected to said support frame.

15. The small camper carrier frame assembly of claim 11, wherein at least four support legs are pivotably connected to said support frame.

16. The small camper carrier frame assembly of claim 15, wherein wheel means are connected to said support frame.
